(19) United States
(12) Patent Application Publication
(10) Pub. No.: US 2004/0154812 A1
(43) Pub. Date: Aug. 12, 2004

(54) Stake driver hand tool

(76) Inventor: Jon Anthony McDonald, Woodland Hills, CA (US)

Correspondence Address: Marshall E. Rosenberg, The Gilbert Law Building, 22130 Clarendon Street, Woodland Hills, CA, 91367, US

(21) Appl. No.: 10/360,839

(22) Filed: Feb. 7, 2003

(51) Int. Cl. B25D 9/00

(52) U.S. Cl. 173/90

(57) ABSTRACT

A stake and post driver having a sleeved construction topped with an expanded impact head is disclosed. The stake driver body is provided with a concavity for receiving an exposed end of the stake or post to be driven. The concavity is sized and shaped to receive the exposed end of the stake along a length sufficient to grip and support the stake or post during the entirety of the driving operation. The impact head is sized and configured to provide an enhanced “sweet spot” targeted by the user, thereby reducing the prior art requirement for essentially total accuracy in exactly delivering a significant driving impact from a manual driver such as a sledge hammer, mallet or other hand-held mechanical driving means to the typically small target of the exposed end of the stake or post to be driven. One or more spacer are provided to be removably installed in the stake driver, the spacer having a receiving recess for supporting a stake against substantial lateral motion during driving installation of a stake or post.

### CROSS-REFERENCE TO RELATED APPLICATIONS

not applicable

### STATEMENT RE: FEDERALLY SPONSORED RESEARCH/DEVELOPMENT:

not applicable

### BACKGROUND OF THE INVENTION

1. Field of the Invention

The present invention relates to apparatus for setting upright supports such as stakes, posts and the like, and more particularly, to a hand tool for use in driving support stakes, grade stakes, posts and the like into the ground or other support surface.

2. Description of the Related Art

Stakes, such as support stakes, grade stakes, posts, rods and spikes are commonly used in numerous applications in a variety of industries including but not limited to the construction industry. By way of example, support stakes are well known for use in supporting concrete form members during the various process steps including the pouring, setting and curing stages of a concrete pour. Also, many construction projects require the excavation and/or the use of field material to produce a grade having a desired specific elevation, and it may be necessary to mark specified elevations at predetermined locations followed by the installation of the appropriate grade stake by mechanically driving it into the ground. Support stakes are known for use in connection with the erection of fences. A variety of stakes and posts of various constructions are known, but often have in common a generally narrow, prismatic profile extending to and including the top exposed end thereof. No matter the application, however, the process of manually driving posts and stakes into the ground can be a labor intensive job, requiring continuing accuracy in swinging a hammer or a mallet to consistently and directly meet the typically narrow upper end of most stakes and posts, while concurrently directing substantial mechanical force thereto.

This requirement becomes even more apparent as a cleanly driven stake or post requires squarely meeting and consistently impacting the exposed head of the stake or post for the full number of impacts necessary to drive the lower portion of the stake or post to its desired depth into the ground or other support surface. Given the oftentimes varied terrain in which stakes and posts are to be installed, it has become apparent that various ones of the powered prior art stake and post drivers would be either difficult, ungainly, or logistically unsafe to use in many situations due to their weight and size. Moreover, such self-powered prior art apparatus may be prohibitively expensive for most casual or amateur users.

Accordingly, there exists a need for a manually-operated apparatus that overcomes the substantial shortcomings of the prior art, that desired apparatus useful for consistently and predictably assisting in driving a stake or post to a desired depth in the ground or other support surface, the manually-operated apparatus preferably having a portable and compact configuration.

### OBJECTS AND SUMMARY OF THE INVENTION

Accordingly, it is an object of the present invention to provide an apparatus for use with a hand-held impact driver for driving a stake or post into the ground or other support surface.

It is another object of the present invention to provide an improved stake driver apparatus for manual use, having improved impacting and driving characteristics.

It is a further object of the present invention to provide an improvement for supporting and driving a stake or post using hand-held manual impact means that is easily and readily affixed and removed by the professional and amateur alike, and once properly installed with the stake or post to be driven, provides consistent installation results irrespective of a user's strength or endurance.

According to the present invention, the stake and post driver of the present invention includes a sleeved construction having a concavity for receiving an exposed end of the stake or post to be driven, the stake and post driver including at the opposite end thereof an enhanced impact receiving head. The concavity is sized and shaped to receive the exposed end of the stake along a length sufficient to grip and support the stake or post during the entirety of the driving operation. The impact head is sized and configured to provide an enhanced “sweet spot” targeted by the user, thereby reducing the prior art requirement for essentially total accuracy in exactly delivering a significant driving impact from a manual driver such as a sledge hammer, mallet or other hand-held mechanical driving means to the typically small target of the exposed end of the stake or post to be driven.

Accordingly, these features improve installation performance by enabling a greater percentage of driving impacts to be beneficially delivered to the impact head, thus improving installation efficiency when an impact force delivered by a hammer or mallet is directly transferred through the inventive apparatus to the upper end of the stake or post with sufficient force to drive the opposite, lower stake or post end into the ground to the desired depth. One or more spacers or bushings may be fitted to the concavity of the stake driver, the spacer(s) or bushing(s) being configured to support a stake end against substantial unintended transverse motion within the cavity of the stake driver, thus further improving operational efficiency of the inventive apparatus. It is further desired that such apparatus be relatively compact, lightweight, and durable to ensure its continued usability, with good portability and durability, by incorporating a strong, durable construction.

### BRIEF DESCRIPTION OF THE DRAWINGS

FIG. 1 is a perspective, partially broken and exploded view of the stake driver hand tool of the present invention, showing a concavity into which an upper end of a stake is to be received prior to installation in the ground or other support surface, according to one embodiment of the present invention.

FIG. 2 is an elevational view of the stake driver of the present invention, showing an upper end of the stake shown in FIG. 1 fully received there in, the stake having a lower end shown as being partially installed in the ground or other support surface.

FIG. 3 is a perspective, exploded view of the stake driver shown in FIGS. 1 and 2, further showing a spacer for use therewith having a receiving recess for supporting a stake against substantial lateral motion, the receiving recess shown having a generally rectilinear cross-sectional shape.

FIG. 4 is a perspective, exploded view of the stake driver shown in FIGS. 1-2, further showing a spacer for use therewith having a receiving recess for supporting a stake against substantial lateral motion, the receiving recess shown having a generally cylindrical cross-sectional shape.

FIG. 5 is a cross-sectional view of the stake driver according to another embodiment of the present invention having a generally cylindrical construction, further showing a complementary-shaped spacer for use therewith having a receiving recess for supporting a stake against substantial lateral motion.

FIG. 6 is a partial perspective exploded view of the stake driver shown in FIG. 5.

### DETAILED DESCRIPTION OF THE PREFERRED EMBODIMENTS

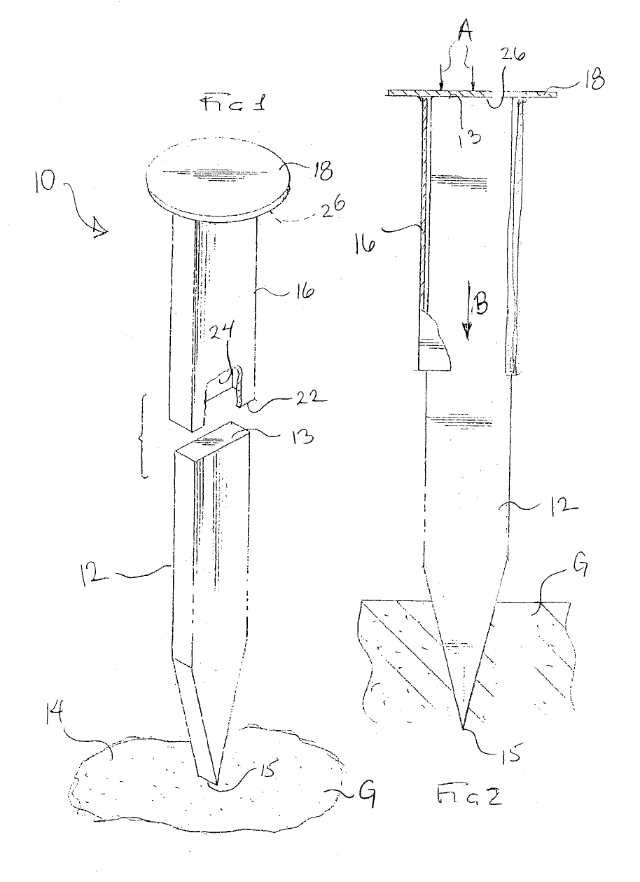

Referring now to the drawings wherein like numerals designate like and corresponding parts throughout the several views, FIGS. 1 and 2 show the stake driver hand tool 10 of the present invention, hereinafter referred to as stake driver 10, positioned to secure a stake or post 12 to be installed in the ground or other support surface 14, introduced therein by leading edge or point 15 of stake or post 12. According to one embodiment, stake driver 10 is provided with a generally prismatic body 16 (although as further described in connection with additional embodiments of the present invention, such body 16 may be provided with alternative shapes including cylindrical or oval) having an impact head 18 provided at one end thereof, the generally prismatic body 16 being provided at the opposite end 20 thereof with an opening 22 to a concavity 24 extending into the body 16. As will be more fully described below, a stake driver 10 having a specific body configuration and concavity 22 and its opening 22 may be selected to accommodate stakes or posts for use in specific driving applications, and further, such stakes or posts may be used with the present invention to secure them in an upright or other orientation as required or desired by the dictates of a particular work plan.

As will be apparent to the skilled artisan, stake driver body 16 is sized and shaped to provide a concavity 22 with a depth sufficient to receive and support a length of the exposed end of the stake or post 12 to be driven, whereby it will be appreciated that the concavity 22 is deep enough to fully encompass a desired length of the exposed end of the stake or post 12 necessary to temporarily but securely position the stake driver 10 on the stake 12 during impact loading applications, but yet not be of such dimension as to compromise portability of the inventive apparatus. It will be further apparent that overall length and width of the stake driver body 16 may be varied to meet desired stake and loading requirements. Thus, a stake driver 10 for use with a particularly stiff stake or post may be provided with a relatively shallow concavity depth of about 4 inches, while a stake driver 10 for use with a post or rod fabricated of a relatively more flexible or construction may have a concavity depth and associated body 16 of a significantly greater dimension as will be appreciated by the skilled artisan. It is further contemplated that a set or kit of stake drivers 10 each having a unique length may be provided to the installation worker to accommodate differing workpiece requirements.

According to one embodiment, the stake driver body is fabricated of sheet steel material to define a stake receiving pocket extending to the underside 26 of impact head 18, the impact head 18 being fabricated of high impact, heat treated steel welded to the pocket of so-formed sheet steel forming driver body 16. Thus constructed, driver body 16 is configured to receive any manner of stake or post 12 to be driven, including for example those with metal or wood constructions, which are slidingly received within the driver body 16 such that an exposed end 13 thereof is brought into direct contact with the underside 26 of impact head 18. In that fully nested position, an impact load from a hammer or mallet applied to impact head 18 in the direction of arrows A will cause the stake driver 10 to urge the stake or post 16 in the direction of arrow B (shown downward for a ground-based installation) to urge stake or post 12 to be advanced via leading edge or point 15 into the ground G or any other support surface in which such installation is desired.

Impact head 18 may be generally disc-shaped as shown, or may be provided in any other shape necessary or desired to readily receive an impact blow from a handheld mechanical driving means including but not limited to hammers and mallets. That is, the impact head 18 is sized and configured to provide an enhanced “sweet spot” to be targeted by the user, thereby reducing the prior art requirement for essentially total accuracy in exactly delivering a significant driving impact from a manual driver such as a sledge hammer, mallet or other hand-held mechanical driving means to the typically small target of the exposed end of the stake or post to be driven. In accordance with the invention, the impact head 18 is sized to readily receive a hammer or mallet impact load over an area significantly broader than the relatively small cross-sectional area provided by exposed end of the stake or post to be driven. Additionally, a protective coating or layer or rubber or other material (not shown) may be adhered to the impact head 18 to provide a non-slip or reduced-slip impact receiving surface, as well as to reduce percussion noise resulting from the necessary mechanical impact required to implement the present invention.

It is further contemplated that stake driver 10 may be fabricated of other durable materials, metallic or non-metallic, capable of accepting and transferring impact loads without fracture. By way of example, a rubber construction is contemplated, either in its entirety or as a hybrid construction whereby the driver body and/or impact head is fabricated of such alternate material. Accordingly, the impact head may be of the same or different material of construction than the driver body, and may be integrally formed with the driver body, or affixed together as disparate elements using known securing means. It is further contemplated that in the case of the use of separate impact head and driver body components, such securing means may allow for field selection, assembly and disassembly of those separate components.

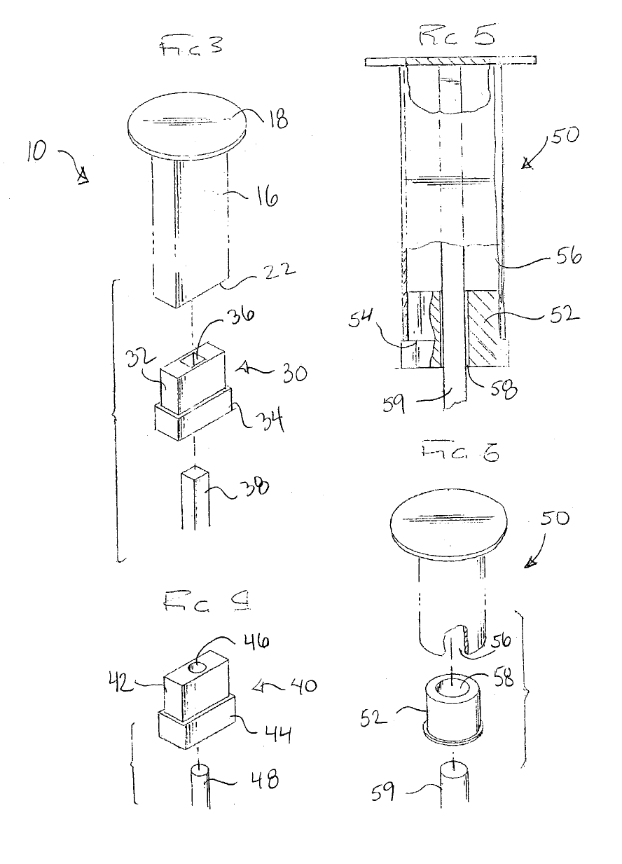

With reference now to FIGS. 3 and 4, the inventive apparatus is contemplated for use in driving all manner of stakes and posts into various support surfaces. However, stakes and posts are known to be available in a wide variety of cross-sectional configurations, not necessarily having the regular, rectangular cross-section of stake 12 shown in FIGS. 1 and 2. Accordingly, it is further contemplated to provide one or more spacers or bushings 30, 40 to be removably fitted to the opening 22 of concavity 24 of stake driver 10, the spacer(s) or bushing(s) 30, 40 being configured to support a longitudinal extent of a stake having a corresponding cross-sectional configuration. To achieve this each spacer 30, 40 includes a complementary-shaped outer periphery 32, 42, respectively for nesting within the opening 22 of stake driver 10, terminating at a shoulder 34, 44, respectively extending adjacent the opening 22 to enable easy assembly and disassembly.

A recess 36, 46 is formed in spacers 30, 40 with a shape complementary to the shape of the stake or post end 38, 48, respectively against substantial unintended transverse motion within the cavity of the stake driver, thus further improving operational efficiency of the inventive apparatus. Although the spacers 30, 40 are shown having recesses for accommodating square and round stakes 38, 48, respectively, it will be apparent that spacers may be configured as necessary and desired to accommodate any other regularly or irregularly-shaped stake or post to be used with the stake driver 10 of the present invention. To further accommodate installation of individual stakes, the spacers 30, 40 may be fabricated of a flexible rubber-based or polymeric material so as to be readily fitted to opening 22 of stake driver 10 with an interference fit via outer periphery 32, 42, yet with a low friction surface texture or finish to ease projection of the stake or post 12 through recesses 36, 46. It is further contemplated that one or more such spacers may be packaged with a set of stakes for use with the stake driver 10 of the present invention, to thereby provide the installation worker with the desired spacer(s) at the job site.

With reference now to FIGS. 5 and 6, the inventive apparatus is contemplated for use in driving all manner of stakes and posts into various support surfaces as previously noted. However, it is further contemplated to form the stake driver of the present invention with cross-sectional configurations different than the generally rectangular cross-section shown in connection with the embodiment of FIGS. 1-4. Specifically, stake driver 50 may be configured with a generally cylindrical configuration, retaining all other features in the manner described above. Alternatively, such configuration may be oval or other regular or irregular configuration as necessary or desired to accommodate stakes or posts having common or specific configurations that may optionally comport closely with the selected configuration. Further, such selected configuration may include either topically or as an integral component of its configuration hand and finger grip portions including textured coatings or films, and/or recesses and/or protrusions to provide an enhanced grip during use or transport. Accordingly, the invention further includes a spacer or bushing 52 having a cylindrical (or other shaped) outer periphery comporting with a corresponding cylindrical opening 54, opening to concavity 56 of stake driver 50, the spacer 52 further provided with a recess 58 formed therethrough with any desired shape complementary to the shape of the stake or post end 59 to be projected therethrough, to restrict substantial unintended transverse motion within the cavity of the stake driver 50 in the manner previously described.

It is to be understood that the present invention is not limited to the embodiments described above, but encompasses any and all embodiments within the scope of the following claims.

What I claim is:

1. A stake driver for driving a stake with a hand-held force applicator, comprising:
a driver body having a proximal end and a distal end and a concavity extending therebetween, and an opening to the concavity provided at the distal end for receiving a terminal portion of the stake; and
an impact head provided adjacent to the proximal end.

2. The driver hand tool as recited in claim 1, wherein the concavity opening has a guide aperture.

3. The driver hand tool as recited in claim 2, wherein the guide aperture is shaped to a similarly shaped stake.

4. The driver hand tool as recited in claim 3, wherein the guide aperture is disposed central to the concavity opening.

5. The driver hand tool as recited in claim 1, wherein the concavity has a depth.

6. The driver hand tool as recited in claim 5, wherein the driver body has a cross-sectional shape extending substantially the depth of the concavity.

7. The driver hand tool as recited in claim 6, wherein the cross-sectional shape is selected from the group including rectangular, square, and round.

8. The driver hand tool as recited in claim 1, wherein the impact head has a front face and an obverse face, an impact surface on the front face, and a direct load transfer surface provided on the obverse face whereby the obverse face defines the floor of the concavity of the driver body at the proximal end thereof.

9. The driver hand tool as recited in claim 1, wherein the impact head is integrally formed with the driver body in a unitary construction.

10. The driver hand tool as recited in claim 1, wherein the tool is assembled from a driver body separate from the impact head.

11. The driver hand tool as recited in claim 1, further comprising a spacer adapted to conform to the concavity opening, the spacer further including a guide aperture for receiving a longitudinal extent of the stake projected therethrough.

12. The driver hand tool as recited in claim 11, further comprising a set of spacers having a plurality of different guide apertures.

13. A stake driver for driving a stake with a hand-held force applicator, comprising:
a driver body having a proximal end and a distal end and a concavity extending therebetween, and an opening to the concavity provided at the distal end for receiving a terminal portion of the stake; and
an impact head secured to the proximal end, the impact head having a front impact face and an obverse face, the obverse face defining the floor of the concavity of the driver body at the proximal end, whereby an impact load applied to the front impact face is transferred through the impact head to the obverse face, to transfer with direct contact the impact load to the terminal portion of the stake.

14. The stake driver as recited in claim 13, wherein the concavity opening has a guide aperture.

15. The stake driver as recited in claim 14, wherein the guide aperture is shaped to a similarly shaped stake.

16. The stake driver as recited in claim 13, wherein the driver body has a cross-sectional shape extending substantially the depth of the concavity.

17. A spacer for use with a stake driver for driving a stake with a hand-held force applicator, the stake driver having a concavity and an opening thereto for receiving a terminal portion of the stake, the spacer adapted to conform to the concavity opening, the spacer further including a guide aperture for receiving a longitudinal extent of the stake projected therethrough.

18. The spacer as recited in claim 17, further comprising a set of spacers having a plurality of different guide apertures.

19. A kit for driving a stake with a hand-held force applicator, the kit comprising:
a stake driver for driving the stake, the driver including a driver body having a proximal end and a distal end and a concavity extending therebetween, and an opening to the concavity provided at the distal end for receiving a terminal portion of the stake; and an impact head provided adjacent to the proximal end; and
at least one spacer adapted to conform to the concavity opening, the spacer further including a guide aperture for receiving a longitudinal extent of the stake projected therethrough.

20. The kit as recited in claim 19, further comprising a set of spacers having a plurality of shaped guide apertures.
